(19) United States
(12) Patent Application Publication
(10) Pub. No.: US 2012/0137791 A1
(43) Pub. Date: Jun. 7, 2012

(54) SENSING DEVICE FOR SENSING FORCE

(76) Inventors: Chen-Pang KUNG, Zhongli City (TW); Jia-Chong Ho, Zhubei City (TW)

(21) Appl. No.: 13/175,345

(22) Filed: Jul. 1, 2011

(30) Foreign Application Priority Data
Dec. 7, 2010 (TW) 99142678

(51) Int. Cl. G01L 1/14

(52) U.S. Cl. 73/862.626

(57) ABSTRACT

A sensing device for sensing a force is provided. The sensing device includes a soft laminose dielectric structure, a first electrode, a second electrode, at least one third electrode and a measuring element. The soft laminose dielectric structure has a first surface and a second surface opposite to each other. The first electrode is disposed on the first surface. The second electrode is disposed on the second surface. The whole of the second electrode overlaps with the first electrode. The third electrode is disposed on the second surface. The third electrode partially overlaps with the first electrode. The measuring element is used for measuring the electronic characteristic between the first electrode and the second electrode, and for measuring the electronic characteristic between the first electrode and the third electrode.

This application claims the benefit of Taiwan application Serial No. 099142678, filed Dec. 7, 2010, the subject matter of which is incorporated herein by reference.

### BACKGROUND

1. Technical Field

The disclosure relates in general to a sensing device for sensing a force.

2. Description of the Related Art

Along with the advance in technology, a touch key and a touch panel are already provided. In the example of the touch key, the user may input an instruction by pressing or touching the touch type key with his/her finger. Such touch key has been widely used in various home appliances and computer peripheral products.

In the example of the touch panel, the user may input an instruction by touching the touch panel with his/her finger. Such touch panel has been widely used in mobile phone and notebook computer.

However, the touch key and the touch panel as well can only detect whether the key or the panel is touched by the user, and the fields of application are narrow. Currently, such touch key or touch panel can at most be used as an input interface of the electronic device.

### SUMMARY

The disclosure is directed to a sensing device for sensing a force. Through the design of the electrodes and the soft laminose dielectric structure, the magnitude of vertical force as well as the magnitude and direction of horizontal force are sensed via the change in the electronic characteristic between the electrodes.

According to a first aspect of the present disclosure, a sensing device for sensing a force is provided. The sensing device includes a soft laminose dielectric structure, a first electrode, a second electrode, at least one third electrode and a measuring element. The soft laminose dielectric structure has a first surface and a second surface opposite to each other. The first electrode is disposed on the first surface. The second electrode is disposed on the second surface. The whole of the second electrode overlaps with the first electrode. The third electrode is disposed on the second surface. The third electrode partially overlaps with the first electrode. The measuring element is used for measuring the electronic characteristic between the first electrode and the second electrode, and measuring the electronic characteristic between the first electrode and the third electrode.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows a top view of a sensing device for sensing a force of a first embodiment;

FIG. 2 shows a cross-sectional view along a cross-sectional line 2-2 of the sensing device of FIG. 1;

FIG. 3 shows a cross-sectional view along a cross-sectional line 3-3 of the sensing device of FIG. 1;

FIG. 4 shows the sensing device of the first embodiment being pushed towards a first direction;

FIG. 5 shows the sensing device of the first embodiment being pushed towards a second direction;

FIG. 6 shows a top view of a sensing device for sensing a force of a second embodiment;

FIG. 7 shows a top view of a sensing device for sensing a force of a third embodiment;

FIG. 8 shows a cross-sectional view along a sensing device for sensing a force of a fourth embodiment;

FIG. 9 shows a cross-sectional view along a sensing device for sensing a force of a fifth embodiment;

FIG. 10 shows a sensing device for sensing a force of a sixth embodiment;

FIG. 11 shows a cross-sectional view along a cross-sectional line 11-11 of the sensing device of FIG. 10;

FIG. 12 shows a cross-sectional view along a cross-sectional line 12-12 of the sensing device of FIG. 10;

FIG. 13 shows a sensing device for sensing a force of a seventh embodiment;

FIG. 14 shows a cross-sectional view along a cross-sectional line 14-14 of the sensing device of FIG. 13;

FIG. 15 shows a cross-sectional view along a cross-sectional line 15-15 of the sensing device of FIG. 13;

FIG. 16 shows a sensing device for sensing a force of a eighth embodiment;

FIG. 17 shows a cross-sectional view along a cross-sectional line 17-17 of the sensing device of FIG. 16;

FIG. 18 shows a cross-sectional view along a cross-sectional line 18-18 of the sensing device of FIG. 16;

FIG. 19 shows a sensing device for sensing a force of a ninth embodiment;

FIG. 20 shows a cross-sectional view along a cross-sectional line 20-20 of the sensing device of FIG. 19; and

FIG. 21 shows a cross-sectional view along a cross-sectional line 21-21 of the sensing device of FIG. 19.

### DETAILED DESCRIPTION

### First Embodiment

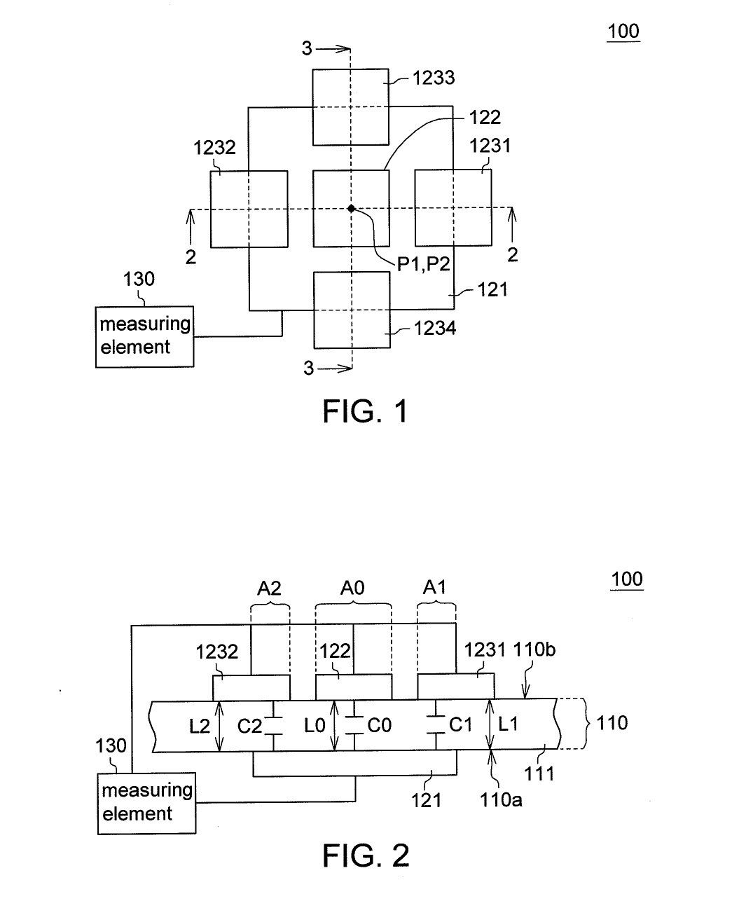

Referring to FIGS. 1˜2. FIG. 1 shows a top view of a sensing device 100 for sensing a force of a first embodiment. FIG. 2 shows a cross-sectional view along a cross-sectional line 2-2 of the sensing device 100 of FIG. 1. The sensing device 100 includes a soft laminose dielectric structure 110 (illustrated in FIG. 2), a first electrode 121, a second electrode 122, four third electrodes 1231, 1232, 1233 and 1234 and a measuring element 130. As indicated in FIG. 2, the soft laminose dielectric structure 110 has a first surface 110a and a second surface 110b opposite to each other. The first electrode 121 is disposed on the first surface 110a. The second electrode 122 and the third electrodes 1231, 1232, 1233 and 1234 are disposed on the second surface 110b. In the present embodiment of the disclosure, the number of the third electrodes 1231, 1232, 1233 and 1234 is exemplified by four, while in another embodiment, there can be one, two or more than four third electrodes.

In FIG. 1, the first electrode 121 is disposed at the bottom while the second electrode 122 and the third electrodes 1231, 1232, 1233 and 1234 are disposed at the top, and the edges of the occluded first electrode 121 are denoted in dotted lines. In terms of overlapping relationships, the whole of the second electrode 122 overlaps with the first electrode 121 (the second electrode 122 is completely located within the coverage of the first electrode 121), and each of the third electrodes 1231, 1232, 1233 and 1234 only partially overlaps with the first electrode 121 (the first electrode 121 and each of the third electrodes 1231, 1232, 1233 and 1234 are partially overlapped).

In terms of shape, as indicated in FIG. 1, the first electrode 121, the second electrode 122 and the third electrodes 1231, 1232, 1233 and 1234 can be circular or polygonal. In the present embodiment of the disclosure, the first electrode 121, the second electrode 122 and the third electrodes 1231, 1232, 1233 and 1234 are all squared.

In terms of area, as indicated in FIG. 1, the area of the first electrode 121 is larger than that of the second electrode 122, and the area of each of the third electrodes 1231, 1232, 1233 and 1234 is substantially equal to each other.

In terms of location relationship, as indicated in FIG. 1, the central point P1 of the first electrode 121 substantially overlaps the central point P2 of the second electrode 122, the third electrodes 1231, 1232, 1233 and 1234 are symmetric with respect to the central point P1 of the first electrode 121 and surround the peripheral of the second electrode 122, and the gaps between the third electrodes 1231, 1232, 1233 and 1234 and the second electrode 122 are substantially equal to each other.

In the present embodiment of the disclosure, the number of the third electrodes 1231, 1232, 1233 and 1234 is four, and the third electrodes 1231, 1232, 1233 and 1234 are disposed on four lateral sides of the first electrode 121.

Referring to FIG. 2, the electronic characteristic between the first electrode 121 and the second electrode 122 is capacitance, and the electronic characteristic between the first electrode 121 and each of the third electrodes 1231, 1232, 1233 and 1234 is also capacitance.

After the electronic characteristics are measured, the measuring element 130 further analyzes the measured electronic characteristics so as to identify the magnitude and direction of the force applied to the sensing device 100 by the user.

Referring to FIG. 2, the soft laminose dielectric structure 110 includes a dielectric material 111. The dielectric material 111 is continuously disposed between the first electrode 121 and the second electrode 122, and continuously disposed between the first electrode 121 and the third electrodes 1231, 1232, 1233 and 1234.

The capacitance C0 between the first electrode 121 and the second electrode 122, the overlapping area A0 between the first electrode 121 and the second electrode 122, the distance L0 between the first electrode 121 and the second electrode 122, and the dielectric constant ε of the dielectric material are conformed to the formula below:

$$C 0 = ɛ \frac{A 0}{L 0} \qquad ( 1 )$$

Similarly, the capacitance C1 between the first electrode 121 and the third electrode 1231, the overlapping area A1 between the first electrode 121 and the third electrode 1231, the distance L1 between the first electrode 121 and the third electrode 1231, and the dielectric constant ε of the dielectric material are conformed to the formula below:

$$C 1 = ɛ \frac{A 1}{L 1} \qquad ( 2 )$$

Similarly, the capacitance C2 between the first electrode 121 and the third electrode 1232, the overlapping area A2 between the first electrode 121 and the third electrode 1232, the distance L2 between the first electrode 121 and the third electrode 1232, and the dielectric constant ε of the dielectric material 111 are conformed to the formula below:

$$C 2 = ɛ \frac{A 2}{L 2} \qquad ( 3 )$$

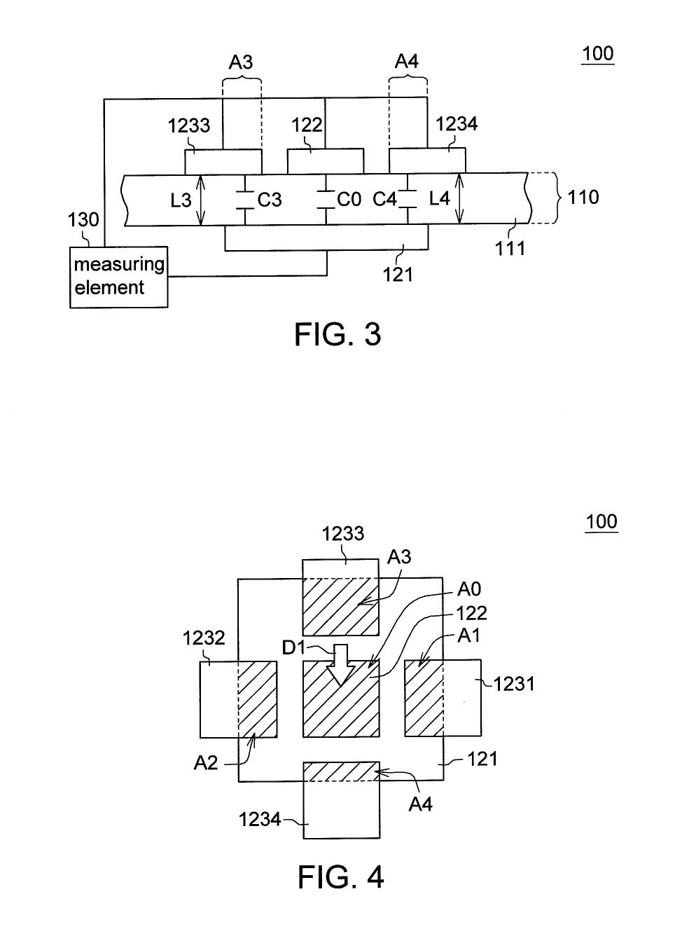

Referring to FIG. 3, a cross-sectional view along a cross-sectional line 3-3 of the sensing device 100 of FIG. 1 is shown. Similarly, the capacitance C3 between the first electrode 121 and the third electrode 1233, the overlapping area A3 between the first electrode 121 and the third electrode 1233, the distance L3 between the first electrode 121 and the third electrode 1233, and the dielectric constant E of the dielectric material 111 are conformed to the formula below:

$$C 3 = ɛ \frac{A 3}{L 3} \qquad ( 4 )$$

Similarly, the capacitance C4 between the first electrode 121 and the third electrode 1234, the overlapping area A4 between the first electrode 121 and the third electrode 1234, the distance L4 between the first electrode 121 and the third electrode 1234, and the dielectric constant ε of the dielectric material 111 are conformed to the formula below:

$$C 4 = ɛ \frac{A 4}{L 4} \qquad ( 5 )$$

When a force is applied to the dielectric material 111, the force is decomposed into a vertical force and a horizontal force. The vertical force deforms the dielectric material 111 in a vertical direction, while the horizontal force displaces the dielectric material 111 in the horizontal direction.

Referring to FIG. 4, the sensing device 100 of the first embodiment being pushed towards a first direction D1 is shown. The slash pattern denotes the range of the overlapping areas A0, A1, A2, A3 and A4. When the sensing device 100 is pushed towards the first direction D1 by a force F, the distances L0, L1, L2, L3 and L4 (illustrated in FIGS. 2-3) will be compressed and shrink, the overlapping areas A0, A1 and A2 will not change, the overlapping area A3 will increase, and the overlapping area A4 will decrease. Thus, according to the above formulas (1)˜(5), the capacitances C0, C1 and C2 will increase, the capacitance C3 will be greater than the capacitances C1, C2, and the capacitance C4 will be less than the capacitances C1 and C2.

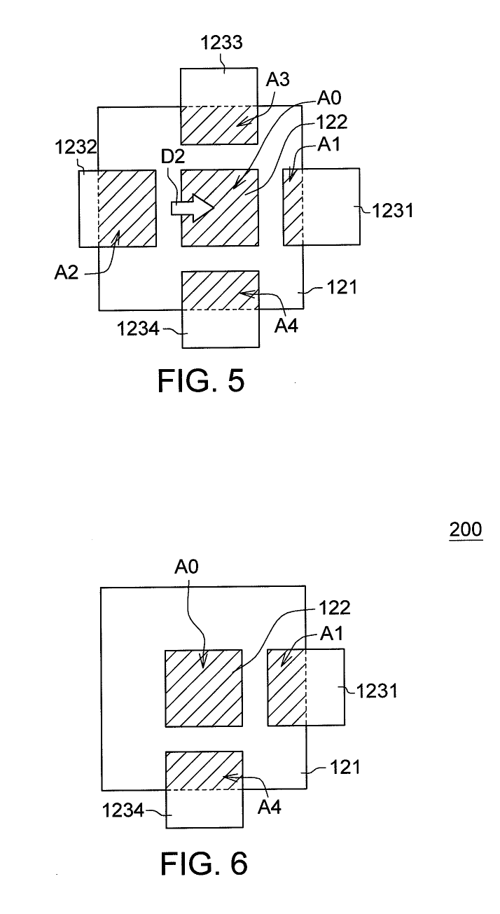

Referring to FIG. 5, the sensing device 100 of the first embodiment being pushed towards a second direction D2 is shown. The slash pattern denotes the range of the overlapping areas A0, A1, A2, A3 and A4. When the sensing device 100 is pushed towards a second direction D2, the distances L0, L1, L2, L3 and L4 (illustrated in FIGS. 2-3) will be compressed and shrink, the overlapping areas A0, A3 and A4 will not change, the overlapping area A1 will decrease, and the overlapping area A2 will increase.

Thus, according to the above formulas (1)˜(5), the capacitances C0, C3 and C4 will increase, the capacitance C1 will be less than the capacitances C3 and C4, and the capacitance C2 will be greater than the capacitances C3, C4.

Similarly, when the sensing device 100 is pushed towards a direction opposite to the first direction D1 or when the sensing device 100 is pushed towards a direction opposite to the second direction D2, similar changes will occur to the capacitances C0, C1, C2, C3, and C4, and the similarities are not repeated here. That is, the moving direction of the sensing device 100 when pushed by a force can be understood by way of analyzing the changes of the capacitances C0, C1, C2, C3, and C4.

To summarize, ordinary touch key or pressure sensing device can only analyze the magnitude of vertical force but cannot estimate the directionality of the applied force. The sensing device 100 of the present disclosure not only senses the magnitude of vertical force but also measures the magnitude and direction of horizontal force via the change in the electronic characteristics between the electrodes.

In terms of product application, the sensing device 100 can be used as touch key or touch panel.

In an embodiment, the sensing device 100 can be disposed on a thin film in the form of matrix. When the user applies a force on the sensing device 100, each sensing device 100 can be used for analyzing the magnitude and direction of the applied force, and can thus be used in some products with special purpose. For example, the sensing device 100 can be used in shoe pads, shoes, clothes or gloves for sensing the vertical and horizontal force applied on shoe pads, shoes, clothes or gloves by the user's motion. In the field of biomedical industry, the user's abnormal motion can further be corrected according to the analysis of the applied force.

### Second Embodiment

Referring to FIG. 6, a top view of a sensing device 200 for sensing a force of a second embodiment is shown. The sensing device 200 of the present embodiment of the disclosure is different from the sensing device 100 of the first embodiment in that the sensing device 200 of the present embodiment of the disclosure only has the first electrode 121, the second electrode 122 and the third electrodes 1231 and 1234 but lacks the third electrodes 1232 and 1233. When the sensing device 200 is pushed by a force, the change in the overlapping areas A0, A1 and A4 is analyzed, and the moving direction of the sensing device 200 when pushed by a force can be easily determined.

### Third Embodiment

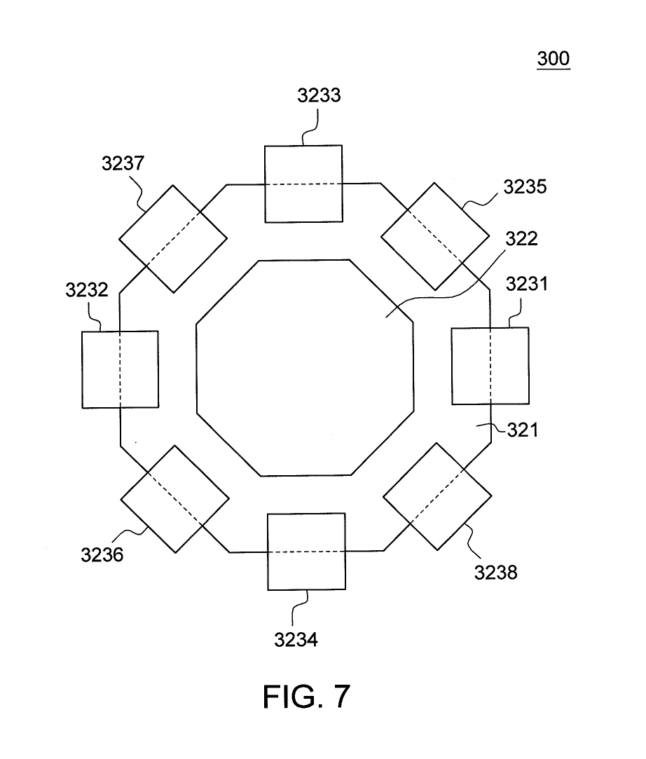

Referring to FIG. 7, a top view of a sensing device 300 for sensing a force of a third embodiment is shown. The sensing device 300 of the present embodiment of the disclosure is different from the sensing device 100 of the first embodiment in that the first electrode 321 and the second electrode 322 of the present embodiment of the disclosure are in the shape of regular octagon, the number of the third electrodes 3231, 3232, 3233, 3234, 3235, 3236, 3237 and 3238 is eight, and the third electrode 3231, 3232, 3233, 3234, 3235, 3236, 3237 and 3238 are disposed on eight lateral sides of the first electrode 321.

Likewise, the eight pushing directions can be easily obtained via the above method of determining capacitance.

### Fourth Embodiment

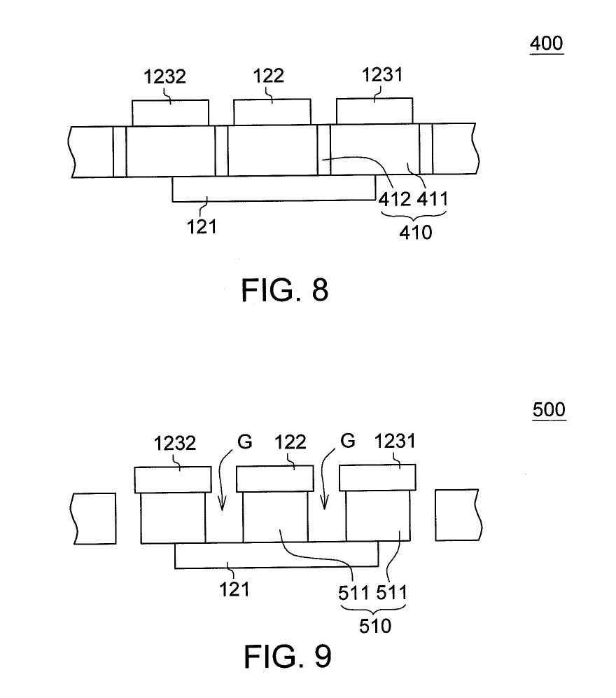

Referring to FIG. 8, a cross-sectional view along a sensing device 400 for sensing a force of a fourth embodiment is shown. The sensing device 400 of the present embodiment of the disclosure is different from the sensing device 100 of the first embodiment in the soft laminose dielectric structure 410, and the similarities are not repeated here.

As indicated in FIG. 8, the soft laminose dielectric structure 410 of the present embodiment of the disclosure includes a plurality of dielectric materials 411 and a plurality of supporting materials 412. The dielectric materials 411 are separately disposed between the first electrode 121 and the second electrode 122, and between the first electrode 121 and the third electrodes 1231, 1232, 1233 and 1234 (the cross-sectional view of FIG. 8 only illustrates third electrodes 1231 and 1232). The supporting materials 412 connect their adjacent dielectric materials 411, and the hardness of each supporting material 412 is higher than that of each dielectric material 411.

Thus, the soft laminose dielectric structure 410, when pushed by a force, can quickly restore its shape with the support of the supporting material 412.

### Fifth Embodiment

Referring to FIG. 9, a cross-sectional view along a sensing device 500 for sensing a force of a fifth embodiment is shown. The sensing device 500 of the present embodiment of the disclosure is different from the sensing device 100 of the first embodiment in the soft laminose structure 510, and the similarities are not repeated here.

As indicated in FIG. 9, the soft laminose dielectric structure 510 of the present embodiment of the disclosure includes a plurality of dielectric materials 511 separately disposed between the first electrode 121 and the second electrode 122, and between the first electrode 121 and the third electrodes 1231, 1232, 1233 and 1234 (FIG. 9 only illustrates third electrodes 1231 and 1232). Adjacent dielectric materials 511 are spaced by a gap G.

Thus, the soft laminose dielectric structure 510 can be easily deformed when pushed by a force.

According to the first, the fourth and the fifth embodiment disclosed above, different designs of soft laminose dielectric structures 110, 410 and 510 lead to different results, and can thus adapted to the needs of the products.

### Sixth Embodiment

Referring to FIG. 10, a sensing device 600 for sensing a force of a sixth embodiment is shown. The sensing device 600 of the present embodiment of the disclosure is different from the sensing device 100 of the first embodiment in that the electronic characteristics estimated by the measuring element 630 are resistance, and the similarities are not repeated here.

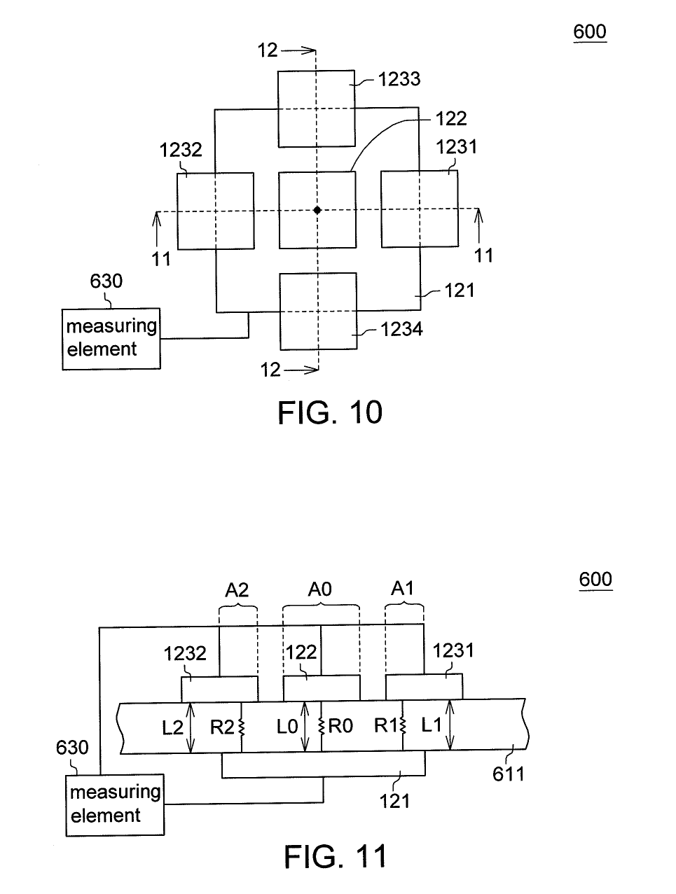

In the present embodiment of the disclosure, the dielectric material 611 (referring to FIG. 11) is made from a material possessing the property of vertical conduction. In the example of the first electrode 121 and the third electrode 1231, only the overlapping part possesses vertical conduction.

Referring to FIG. 11, a cross-sectional view along a cross-sectional line 11-11 of the sensing device 600 of FIG. 10 is shown. The resistance R0 between the first electrode 121 and the second electrode 122, the overlapping area A0 between the first electrode 121 and the second electrode 122, the distance L0 between the first electrode 121 and the second electrode 122, and the resistance coefficient ρ of the dielectric material 611 are conformed to the formula below:

$$R 0 = ρ \frac{L 0}{A 0} \qquad ( 6 )$$

Similarly, the resistance R1 between the first electrode 121 and the third electrode 1231, the overlapping area A1 between the first electrode 121 and the third electrode 1231, the distance L1 between the first electrode 121 and the third electrode 1231, and the resistance coefficient ρ of the dielectric material 611 are conformed to the formula below:

$$R 1 = ρ \frac{L 1}{A 1} \qquad ( 7 )$$

Similarly, the resistance R2 between the first electrode 121 and the third electrode 1232, the overlapping area A2 between the first electrode 121 and the third electrode 1232, the distance L2 between the first electrode 121 and the third electrode 1232, and the resistance coefficient ρ of the dielectric material 611 are conformed to the formula below:

$$R 2 = ρ \frac{L 2}{A 2} \qquad ( 8 )$$

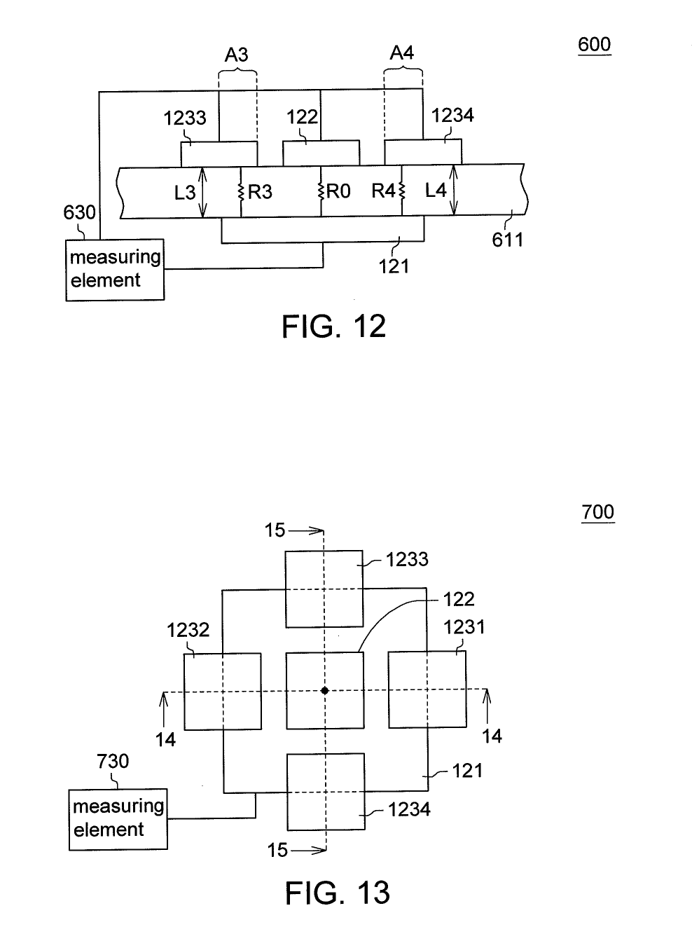

Again, referring to FIG. 12, a cross-sectional view along a cross-sectional line 12-12 of the sensing device 600 of FIG. 10 is shown. Similarly, the resistance R3 between the first electrode 121 and the third electrode 1233, the overlapping area A3 between the first electrode 121 and the third electrode 1233, the distance L3 between the first electrode 121 and the third electrode 1233, and the dielectric constant ρ of the dielectric material 611 are conformed to the formula below:

$$R 3 = ρ \frac{L 3}{A 3} \qquad ( 9 )$$

Similarly, the resistance R4 between the first electrode 121 and the third electrode 1234, the overlapping area A4 between the first electrode 121 and the third electrode 1234, the distance L4 between the first electrode 121 and the third electrode 1234, and the dielectric constant ρ of the dielectric material 611 are conformed to the formula below:

$$R 4 = ρ \frac{L 4}{A 4} \qquad ( 10 )$$

When the sensing device 600 is pushed by a force, the changes in the distances L0, L1, L2, L3 and L4 and the overlapping areas A0, A1, A2, A3 and A4 will affect the resistances R0, R1, R2, R3 and R4. Therefore, like the method of analysis adapted in the first embodiment, the measuring element 630 only needs to analyze the changes in the resistances R0, R1, R2, R3 and R4, and the moving direction of the sensing device 600 will be obtained accordingly when the sensing device 600 is pushed by a force.

### Seventh Embodiment

Referring to FIG. 13, a sensing device 700 for sensing a force of a seventh embodiment is shown. The sensing device 700 of the present embodiment of the disclosure is different from the sensing device 100 of the first embodiment in that the electronic characteristics estimated by the measuring element 730 are mixed with capacitance and resistance, and the similarities are not repeated here.

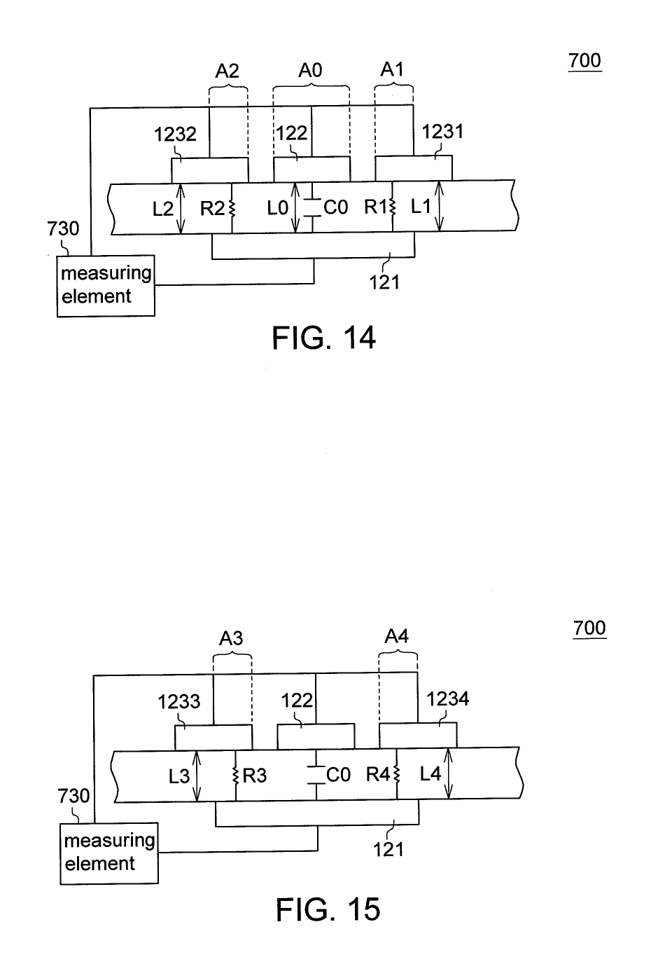

Referring to FIG. 14, a cross-sectional view along a cross-sectional line 14-14 of the sensing device 700 of FIG. 13 is shown. Referring to FIG. 15, a cross-sectional view along a cross-sectional line 15-15 of the sensing device 700 of FIG. 13 is shown. When the sensing device 700 is pushed by a force, the changes in the distances L0, L1, L2, L3 and L4 and the overlapping areas A0, A1, A2, A3 and A4 will affect the capacitance C0 and the resistances R1, R2, R3, R4. Therefore, like the method of analysis adapted in the first embodiment, the measuring element 730 only needs to analyze the changes in the capacitance C0 and the resistances R1,

R2, R3, R4, and the moving direction of the sensing device 700 will be obtained accordingly when the sensing device 700 is pushed by a force.

### Eighth Embodiment

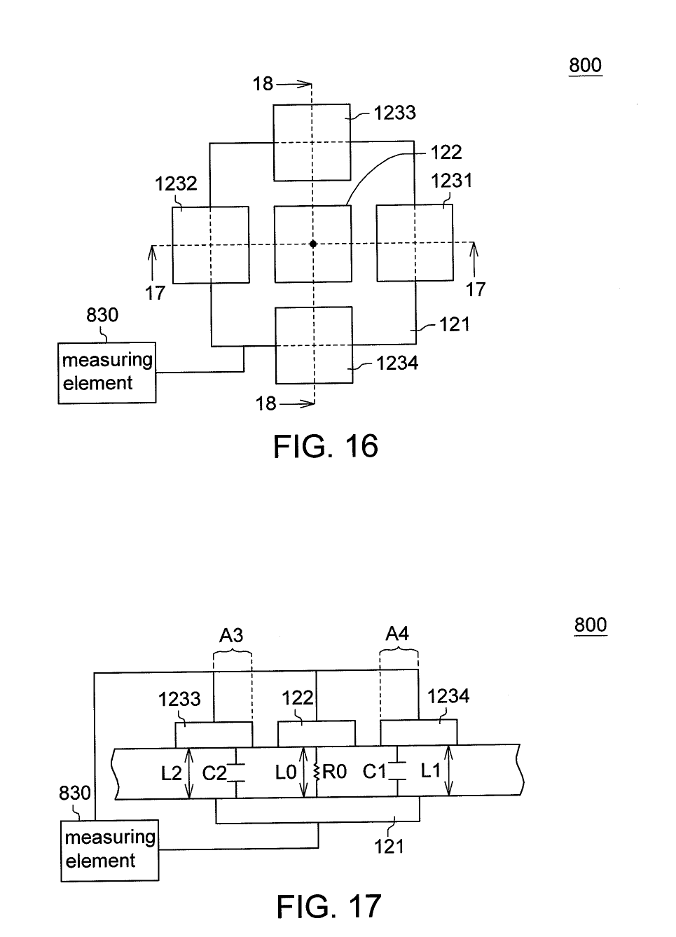

Referring to FIG. 16, a sensing device 800 for sensing a force of a eighth embodiment is shown. The sensing device 800 of the present embodiment of the disclosure is different from the sensing device 100 of the first embodiment in that the electronic characteristics estimated by the measuring element 830 are mixed with capacitance and resistance, and the similarities are not repeated here.

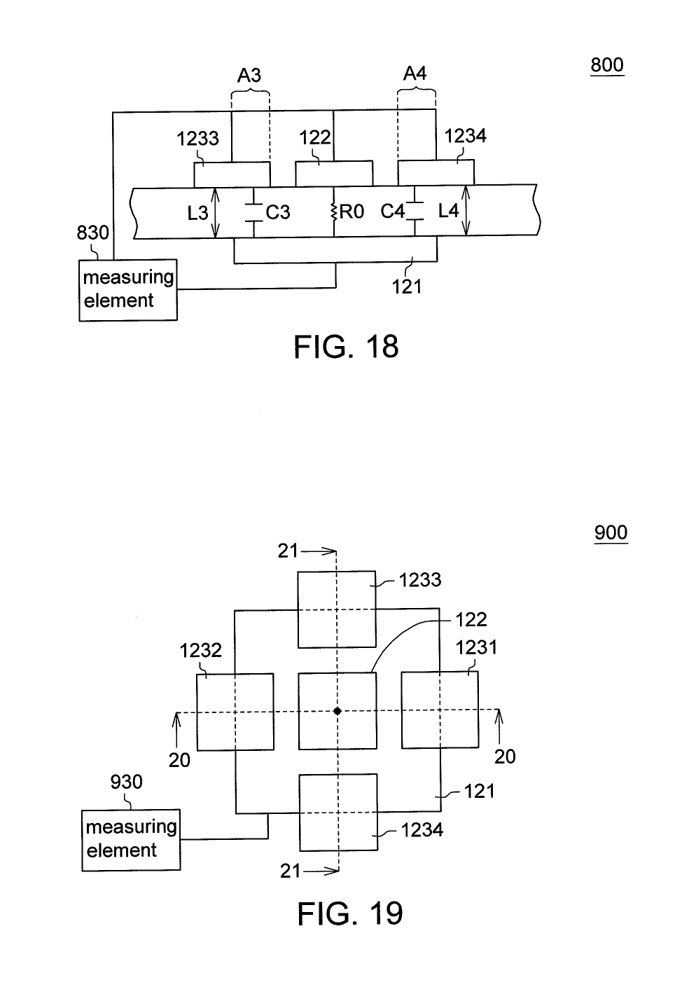

Referring to FIG. 17, a cross-sectional view along a cross-sectional line 17-17 of the sensing device 800 of FIG. 16 is shown. Referring to FIG. 18, a cross-sectional view along a cross-sectional line 18-18 of the sensing device 800 of FIG. 16 is shown. When the sensing device 800 is pushed by a force, the changes in the distances L0, L1, L2, L3 and L4 and the overlapping areas A0, A1, A2, A3 and A4 will affect the capacitances C1, C2, C3, C4 and the resistance R0. Therefore, like the method of analysis adapted in the first embodiment, the measuring element 830 only needs to analyze the changes in the capacitances C1, C2, C3, C4 and the resistance R0, and the moving direction of the sensing device 800 will be obtained accordingly when the sensing device 800 is pushed by a force.

### Ninth Embodiment

Referring to FIG. 19, a sensing device 900 for sensing a force of a ninth embodiment is shown. The sensing device 900 of the present embodiment of the disclosure is different from the sensing device 100 of the first embodiment in that the electronic characteristics estimated by the measuring element 930 are mixed with capacitance and resistance, and the similarities are not repeated here.

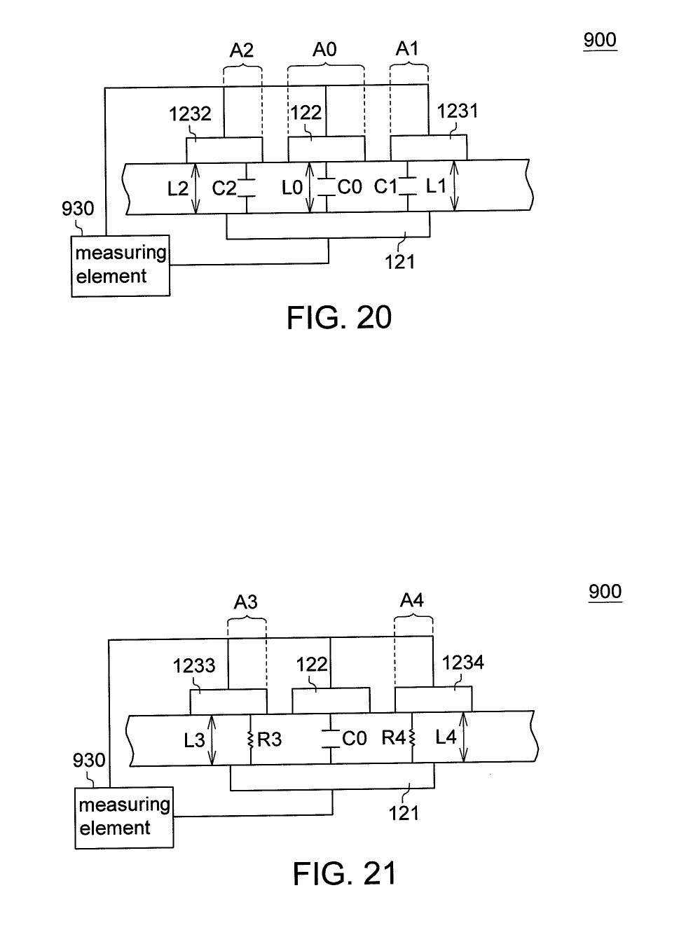

Referring to FIG. 20, a cross-sectional view along a cross-sectional line 20-20 of the sensing device 900 of FIG. 19 is shown. Referring to FIG. 21, a cross-sectional view along a cross-sectional line 21-21 of the sensing device 900 of FIG. 19 is shown. When the sensing device 900 is pushed by a force, the changes in the distances L0, L1, L2, L3 and L4 and the overlapping areas A0, A1, A2, A3 and A4 will affect the capacitances C0, C1, C2 and the resistances R3, R4. Therefore, like the method of analysis adapted in the first embodiment, the measuring element 930 only needs to analyze the changes in the capacitances C0, C1, C2 and the resistances R3, R4, and the moving direction of the sensing device 900 will be obtained accordingly when the sensing device 900 is pushed by a force.

In one embodiment, the electronic characteristic between two of the electrodes can be mixed with capacitance and resistance. When the sensing device is pushed by a force, it will affect the capacitances and the resistances. The moving direction of the sensing device can be obtained by an analysis method accordingly when the sensing device is pushed by a force.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A sensing device for sensing a force, comprising:
a soft laminose dielectric structure having a first surface and a second surface opposite to each other;
a first electrode disposed on the first surface;
a second electrode disposed on the second surface, wherein the whole of the second electrode overlaps with the first electrode;
at least one third electrode disposed on the second surface, wherein the third electrode partially overlaps with the first electrode; and
a measuring element used for measuring the electronic characteristic between the first electrode and the second electrode, and for measuring the electronic characteristic between the first electrode and the third electrode.

2. The sensing device according to claim 1, wherein the first electrode is circular or polygonal.

3. The sensing device according to claim 1, wherein the first electrode is squared, and the third electrode is disposed on a lateral side of the first electrode.

4. The sensing device according to claim 1, wherein the electronic characteristic between the first electrode and the second electrode is capacitance, and the electronic characteristic between the first electrode and the third electrode is capacitance.

5. The sensing device according to claim 1, wherein the electronic characteristic between the first electrode and the second electrode is resistance, and the electronic characteristic between the first electrode and the third electrode is resistance.

6. The sensing device according to claim 1, wherein the electronic characteristic between the first electrode and the second electrode is resistance, and the electronic characteristic between the first electrode and the third electrode is capacitance.

7. The sensing device according to claim 1, wherein the electronic characteristic between the first electrode and the second electrode is capacitance, and the electronic characteristic between the first electrode and the third electrode is resistance.

8. The sensing device according to claim 1, wherein the sensing device comprises at least two third electrodes, the electronic characteristic between the first electrode and the second electrode is capacitance, the electronic characteristic between the first electrode and one of the third electrodes is resistance, and the electronic characteristic between the first electrode and another one of the third electrodes is capacitance.

9. The sensing device according to claim 1, wherein the first electrode is a rectangle, and the third electrode is disposed on a lateral side of the first electrode.

10. The sensing device according to claim 1, wherein the first electrode is a regular octagon, and the third electrode is disposed on a lateral side of the first electrode.

11. The sensing device according to claim 1, wherein the soft laminose dielectric structure comprises:
a dielectric material continuously disposed between the first electrode and the second electrode, and continuously disposed between the first electrode and the third electrode.

12. The sensing device according to claim 1, wherein the soft laminose dielectric structure comprises:
a plurality of dielectric materials separately disposed between the first electrode and the second electrode, and separately disposed between the first electrode and the third electrode; and
a plurality of supporting materials connecting the adjacent dielectric materials, wherein the hardness of each supporting material is higher than that of each dielectric material.

13. The sensing device according to claim 1, wherein the soft laminose dielectric structure comprising:
a plurality of dielectric materials separately disposed between the first electrode and the second electrode, and separately disposed between the first electrode and the third electrode, wherein the adjacent dielectric materials are spaced by a gap.

14. The sensing device according to claim 1, wherein the area of the first electrode is larger than that of the second electrode, and the second electrode is completely located within the coverage of the first electrode.
